(19) United States
(12) Patent Application Publication
(10) Pub. No.: US 2026/0089367 A1
(43) Pub. Date: Mar. 26, 2026

(54) AI-POWERED SYSTEM FOR AUTOMATING VIDEO CONTENT CREATION FROM SCRIPT GENERATION TO MARKET DISTRIBUTION

(71) Applicant: Jethro Rothe-Kushel, Beverly Hills, CA (US)

(72) Inventor: Jethro Rothe-Kushel, Beverly Hills, CA (US)

(21) Appl. No.: 19/334,618

(22) Filed: Sep. 19, 2025

Related U.S. Application Data
(60) Provisional application No. 63/696,897, filed on Sep. 20, 2024.

(51) Int. Cl. H04N 21/81; H04N 21/854

(52) U.S. Cl. CPC H04N 21/816; H04N 21/854

(57) ABSTRACT

An AI-powered system automating video content creation from script generation to market distribution is disclosed. The system integrates natural language processing, storyboarding, virtual production, post-production, and distribution optimization into a unified workflow, eliminating manual intervention. This invention improves on existing systems by offering an integrated, fully automated AI solution that handles every phase of content creation, eliminating the need for manual intervention. It significantly reduces production time and costs by streamlining scriptwriting, storyboarding, virtual production, and post-production into one cohesive process, providing scalability and efficiency that current fragmented tools cannot match.

### CROSS-REFERENCE TO RELATED APPLICATIONS

This application claims the benefit of U.S. Provisional Application No. 63/696,897, filed Sep. 20, 2024, which is hereby incorporated by reference, to the extent that it is not conflicting with the present application.

### BACKGROUND OF INVENTION

### 1. Field of the Invention

The invention relates generally to artificial intelligence systems. More specifically the invention relates to generative artificial intelligence systems.

### 2. Description of the Related Art

Existing systems in content creation often focus on isolated tasks, like scriptwriting, storyboarding, or post-production, which still require significant human intervention. This fragmented approach leads to inefficiencies in production, increased costs, and prolonged timelines, as creators must manually integrate and oversee these separate processes. Furthermore, most current solutions do not offer comprehensive scalability or fully leverage AI to streamline the entire content creation workflow, limiting their ability to significantly reduce production overhead.

Traditional video production requires extensive human labor, coordination across multiple teams, and significant costs. Existing AI tools address isolated tasks—scriptwriting, editing, or visual effects—but do not provide an end-to-end automated solution. There is a need for a fully integrated system that reduces costs, accelerates production timelines, and scales content creation for industries such as advertising, entertainment, and education.

The aspects or the problems and the associated solutions presented in this section could be or could have been pursued; they are not necessarily approaches that have been previously conceived or pursued. Therefore, unless otherwise indicated, it should not be assumed that any of the approaches presented in this section qualify as prior art merely by virtue of their presence in this section of the application.

### BRIEF INVENTION SUMMARY

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

The invention addresses the high costs, long production timelines, and extensive human labor required for traditional content creation in the film and television industries. It solves the inefficiencies in scriptwriting, pre-production planning, filming, and post-production, which often require the collaboration of large teams and significant resources. Additionally, it tackles the challenge of scaling content production while maintaining high quality, making it difficult for creators to meet the increasing demand for diverse and engaging video content.

This invention improves on existing systems by offering an integrated, fully automated AI solution that handles every phase of content creation, eliminating the need for manual intervention. It significantly reduces production time and costs by streamlining scriptwriting, storyboarding, virtual production, and post-production into one cohesive process, providing scalability and efficiency that current fragmented tools cannot match.

The invention provides a fully automated, AI-powered system that integrates all stages of video content creation: script generation, storyboarding, pre-production planning, virtual production, post-production editing, market testing, and optimized distribution. By unifying these stages into one workflow, the system eliminates manual bottlenecks and provides scalability, efficiency, and cost reduction unmatched by fragmented tools.

The above aspects or examples and advantages, as well as other aspects or examples and advantages, will become apparent from the ensuing description and accompanying drawings.

### BRIEF DESCRIPTION OF THE DRAWINGS

For exemplification purposes, and not for limitation purposes, aspects, embodiments or examples of the invention are illustrated in the figures of the accompanying drawings, in which:

FIG. 1 illustrates a chart of automation efficiency, as a percentage, at each stage of the artificial intelligence (AI) content creation process.

FIG. 2 illustrates a chart of production speed improvement, as a percentage, at each stage of the artificial intelligence (AI) content creation process.

FIG. 3 illustrates a chart of production speed improvement, as a percentage, at each stage of the artificial intelligence (AI) content creation process.

FIG. 4 illustrates a flowchart of one embodiment of the AI content creation process.

FIG. 5 illustrates flowchart of one embodiment of the AI content creation process.

FIG. 6 illustrates a block diagram detailing a process flow of one embodiment of an AI-powered system for automating video content creation from script generation to market distribution.

FIG. 7 illustrates a block diagram comparing production metrics (e.g., time, cost, success rate) between traditional content creation and AI enhanced content creation methods.

FIG. 8 illustrates a block diagram of a tech stack architecture that may be used to facilitate an AI-powered system for automating video content creation from script generation to market distribution.

FIG. 9 illustrates a block diagram of advantages of an AI-powered system for automating video content creation from script generation to market distribution.

FIG. 10 illustrates a flowchart of one embodiment of an end-to-end workflow in an AI-powered system for automating video content creation from script generation to market distribution.

### DETAILED DESCRIPTION

What follows is a description of various aspects, embodiments and/or examples in which the invention may be practiced.

The system comprises a user input interface, a natural language processing engine, a script refinement module, a storyboarding module, a pre-production planning module, a virtual production system, a virtual actor simulation module, a post-production module, a market testing module, and a distribution optimization module. These components operate in a sequential or parallel manner, integrated via data pipelines, enabling video content creation without human creative intervention.

As stated above, the invention addresses the high costs, long production timelines, and extensive human labor required for traditional content creation in the film and television industries. It solves the inefficiencies in scriptwriting, pre-production planning, filming, and post-production, which often require the collaboration of large teams and significant resources. Additionally, it tackles the challenge of scaling content production while maintaining high quality, making it difficult for creators to meet the increasing demand for diverse and engaging video content. The invention claimed here solves this problem.

The invention solves these problems by using AI to automate every step of the content creation process. It generates scripts, storyboards, and production schedules, eliminating the need for manual writing, design, and planning. Virtual production technology replaces physical sets and actors, reducing costs and time associated with traditional filming. Post-production tasks like editing, special effects, and sound mixing are also automated, significantly speeding up the process. Finally, AI analytics optimize distribution by predicting audience reactions, making the content creation process scalable, efficient, and cost-effective.

The claimed invention differs from what currently exists. This invention is unique in offering a fully automated, AI-powered system that integrates every stage of content creation, from scriptwriting to distribution. Unlike existing tools that focus on isolated tasks like storyboarding or post-production, this system streamlines the entire process, reducing costs and time more comprehensively than any other solution in the industry.

These systems don't work well because they require manual oversight and integration of separate tasks, leading to bottlenecks in production timelines. Additionally, they fail to fully automate critical stages of content creation, limiting scalability and making it difficult to reduce costs and meet high demand efficiently.

This invention improves on existing systems by offering an integrated, fully automated AI solution that handles every phase of content creation, eliminating the need for manual intervention. It significantly reduces production time and costs by streamlining scriptwriting, storyboarding, virtual production, and post-production into one cohesive process, providing scalability and efficiency that current fragmented tools cannot match.

The invention can produce several useful items, including:
Video Content: Complete, AI-generated videos such as films, commercials, training videos, or social media content.
Scripts: Written scripts based on user inputs, useful for filmmakers, content creators, or marketers.
Visual Storyboards: Automated storyboards that serve as pre-visualizations for video or film production.
Virtual Assets: Digital environments, characters, and sets, which can be used in videos, virtual reality (VR), gaming, or augmented reality (AR).
Interactive Content: Customizable, personalized videos based on audience data or preferences.

These outputs offer practical value across industries such as entertainment, education, marketing, and gaming.

One embodiment of the invention discussed includes:
User Input Interface: A platform where users provide initial inputs such as genre, theme, character traits, and plot points.
Natural Language Processing (NLP) Engine: AI engine that generates narrative scripts based on user input.
Script Refinement Module: Enhances and adjusts scripts based on tone, pacing, and genre using machine learning models.
Storyboarding Module: Automatically generates visual storyboards from the script, including scene composition, camera angles, and lighting.
Pre-Production Planning Module: Automates the creation of production schedules, budgeting, resource allocation, and casting recommendations using AI.
Virtual Production System: Uses generative AI models to create and simulate virtual environments, sets, and actors.
Virtual Actor Simulation Module: Animates virtual characters using pre-trained models or motion-capture data.
Post-Production Module: Automates editing, special effects, color grading, and audio mixing using machine learning algorithms.
Market Testing Module: Simulates audience reactions and provides feedback for content optimization based on AI-driven analytics.
Distribution Optimization Module: Selects the best distribution strategies and platforms using AI to predict audience engagement and viewership trends.

Relationship between the components may be as follows;

The components of the content creation system work together in a highly coordinated and sequential manner, each building upon the previous step to automate the entire content production process. Here's how they relate to each other:

User Input Interface (Component #1): This is the starting point where users provide essential parameters (such as genre, theme, and character traits). The data from this step is passed to the NLP Engine (Component #2). NLP Engine (Component #2): The input from Component #1 is used to generate a structured narrative script. The script is then refined and polished by the Script Refinement Module (Component #3). Script Refinement Module (Component #3): This module adjusts the script for tone, pacing, and genre specific elements. Once the script is finalized, it's sent to the Storyboarding Module (Component #4). Storyboarding Module (Component #4): Using the refined script, this module generates visual storyboards, which include camera angles, scene composition, and lighting plans. These storyboards guide the next stages of production. Pre-Production Planning Module (Component #5): Based on the script and storyboard, this module automates scheduling, budgeting, and casting decisions. It passes the optimized production plan to the Virtual Production System (Component #6). Virtual Production System (Component #6): This system creates and manages virtual sets and actors, using the storyboards from Component #4 and the production plan from Component #5. The virtual characters are animated through the Virtual Actor Simulation Module (Component #7). Virtual Actor Simulation Module (Component #7): This module handles the animation of virtual actors using pre-trained models or motion-capture data. The animated scenes are then sent to the Post-Production Module (Component #8). Virtual Actor Simulation Module (Component #7): This module handles the animation of virtual actors using pre-trained models or motion-capture data. The animated scenes are then sent to the Post-Production Module (Component #8). Post-Production Module (Component #8): After virtual production, this module automates video editing, special effects, and sound mixing. The finished video is ready for market testing, which is handled by the Market Testing Module (Component #9). Market Testing Module (Component #9): This module simulates audience reactions based on historical data and feedback, optimizing the content to maximize audience engagement. The final content is distributed through the Distribution Optimization Module (Component #10). Distribution Optimization Module (Component #10): This final component selects the best distribution strategies, ensuring the content reaches the right audience through optimal platforms and channels.

How the invention works:

The content creation system operates through a series of interdependent, AI-driven modules that work together to automate each phase of the video production process.
User Input Interface: The process begins when a user provides input on the content type (e.g., genre, theme, plot points). This information guides the AI in making decisions throughout the rest of the workflow.
NLP Engine: The Natural Language Processing (NLP) engine takes user inputs and generates a structured narrative script. The engine uses machine learning models trained on large datasets of existing scripts to produce storylines and character dialogues.
Script Refinement Module: Once the NLP generates the script, this module refines it by making adjustments for tone, pacing, and other genre-specific elements, ensuring the script aligns with the user's creative vision. It incorporates feedback loops that allow for iterative improvements.
Storyboarding Module: Using the refined script, this module automatically generates storyboards, which include visual representations of scenes, camera angles, and lighting conditions. The storyboards provide a visual outline of the production and serve as a guide for subsequent stages.
Pre-Production Planning Module: This module takes the script and storyboard and automates pre production tasks such as scheduling, budgeting, and casting decisions. AI optimizes these elements based on available resources and constraints like time and budget.
Virtual Production System: During production, the system replaces traditional filming with virtual production. AI generates digital sets and virtual actors using generative models. These digital assets are animated and controlled by the system, reducing the need for physical actors and locations.
Virtual Actor Simulation Module: This module animates virtual characters using motion-capture data or AI models that replicate human movements and expressions. It ensures realistic character interactions and
Post-Production Module: After the virtual production is completed, this module automates post production tasks such as video editing, special effects, sound design, and color grading. The system uses pre-trained models to apply genre-specific effects and optimize video/audio synchronization.
Market Testing Module: Once the video is complete, AI simulates audience reactions by analyzing demographic and behavioral data. The system tests different versions of the content to optimize for audience engagement, ensuring the content resonates with the intended audience.
Distribution Optimization Module: Finally, the system selects the most appropriate distribution strategies, choosing platforms and channels based on market trends and predictive models. This ensures the content reaches the right audience in the most efficient manner.
How These Components Work Together: Each component operates sequentially and in a tightly integrated manner. For example, the output of the NLP Engine feeds directly into the Script Refinement Module, and the refined script informs the Storyboarding Module. This seamless interaction allows for continuous workflow automation, reducing manual intervention. The AI-driven modules ensure that each phase of production, from script generation to distribution, is optimized for speed, cost-efficiency, and scalability.

In sum, the system automates what would traditionally be a labor-intensive, time-consuming process, streamlining it into a cohesive, AI-powered workflow that can produce high-quality video content quickly and efficiently. This allows creators to meet increasing content demands with fewer resources, making the production process more accessible and scalable. Yes, the content creation system relies heavily on logic, including if-then relationships, subroutines, and decision-making gates. Here are some examples of how these elements are used:
If-Then Relationships: The system uses conditional logic to determine the flow of operations. For instance, in the Script Refinement Module (Component #3), if the user selects a specific genre (e.g., action), then the script will be adjusted to match genre-specific pacing and tone. Similarly, if the audience feedback in the Market Testing Module (Component #9) suggests low engagement, then the system may recommend modifications to the narrative or visual elements.
Subroutines: Various components, like the NLP Engine (Component #2), rely on subroutines to handle different tasks, such as generating dialogue, refining plot points, or adjusting character development based on user input. These subroutines break down complex processes into smaller, manageable steps, which can be called upon as needed.
Decision Gates: Throughout the content creation process, the system evaluates different variables to make decisions. For example, in the Pre-Production Planning Module (Component #5), the system uses decision gates to balance time, budget, and resource availability when scheduling production tasks. Depending on the constraints, the system will select the most efficient course of action for the next stage of production.
How To Make The Invention: To make the iFlix.ai content creation system, follow these key steps:
User Input Interface: Build a user-friendly interface with web technologies (React, Django) to capture genre, plot, and themes.
NLP Engine: Use AI tools like GPT-3 to generate scripts based on user input.
Script Refinement Module: Apply machine learning algorithms to refine pacing, tone, and dialogue.
Storyboarding Module: Use AI image generation (DALLÂ·E, Unreal Engine) to create visual storyboards from the script.
Pre-Production Planning: Implement AI for scheduling, budgeting, and resource allocation based on constraints.
Virtual Production System: Use generative models (Unreal Engine) to create digital sets and animate virtual actors.
Post-Production: Automate video editing, special effects, and audio mixing with AI-driven editing tools (e.g., Adobe AI features).
Market Testing and Distribution: Use AI to predict audience engagement and optimize distribution.
Necessary Elements:
User Input Interface: Essential for gathering user preferences to guide content creation.
NLP Engine: Crucial for generating the initial script, the foundation of the content creation process.
Storyboarding Module: Necessary to convert the script into visual storyboards for production.
Pre-Production Planning: Key for automating scheduling, budgeting, and resource allocation.
Virtual Production System: Required to create digital sets and characters, streamlining production.
Post-Production Module: Needed to automate editing, special effects, and audio tasks.
Optional Elements:
Script Refinement: Helpful but not mandatory; users could manually adjust the script.
Virtual Actor Simulation: Optional if live actors are used instead of virtual ones.
Market Testing and Distribution Optimization: Useful for content optimization and audience targeting but not essential for initial production.
Potential Additions:
AI-Based Content Personalization: Could tailor content to specific audience preferences.
Collaboration Tools: Enhance team productivity with real-time collaboration.
Data Analytics: Track content performance and provide insights for future improvements.

This streamlined structure ensures the system's efficiency, with flexibility to enhance or simplify as needed.

The components of the content creation system can be rearranged or interchanged to maintain similar functionality:
Script Refinement and NLP: Refinement can occur before or after script generation, or even after storyboarding.
Pre-Production and Storyboarding: Pre-production can be done before storyboarding, planning resources first and visualizing later.
Market Testing: Audience testing could happen earlier, during script or storyboard phases.
Virtual Production and Post-Production: These can be parallel processes, applying post-production effects during virtual scene generation.
Distribution and Testing: Distribution data can feedback into market testing to adjust content in real time.

This flexibility ensures the system adapts to various workflows while maintaining automation.
How To Use The Invention: To use the invention, a person would follow these specific steps:
Input Parameters: The user provides key inputs such as genre, themes, plot points, and character traits through the User Input Interface. This step defines the foundation for the content.
Script Generation: The system's NLP Engine generates a narrative script based on the user's input. The user reviews the script and can make adjustments or refinements using the Script Refinement Module.
Storyboarding: The system automatically creates a visual storyboard using the Storyboarding Module, translating the script into visuals with camera angles, lighting, and scene compositions.
Pre-Production Planning: The Pre-Production Planning Module automates the scheduling, budgeting, and resource allocation, optimizing the process based on time and cost constraints.
Virtual Production: The Virtual Production System generates virtual sets and characters, allowing the user to review and modify digital environments or characters before proceeding.
Post-Production: After production, the Post-Production Module automatically edits the footage, applies special effects, and balances audio to complete the video.
Market Testing: The user can then test the content with target audiences through the Market Testing Module, which provides feedback on potential adjustments.
Distribution: Finally, the Distribution Optimization Module ensures the content is delivered to the appropriate platforms and audiences, maximizing its reach.

By following these steps, the user automates and streamlines the content creation process, reducing production time and costs while maintaining high-quality output. Additionally: Yes, the invention can produce a variety of useful items, including:
Video Content: The primary product is fully automated video content, ranging from films, TV shows, and advertisements to educational or corporate training videos.
Scripts and Storyboards: The system generates structured scripts and visual storyboards, which are valuable products in themselves for filmmakers, marketers, or educational institutions.
Virtual Assets: The invention can produce virtual environments, characters, and sets that can be used not only in videos but also in gaming, virtual reality (VR), and augmented reality (AR) applications.
Interactive Experiences: The system's ability to simulate audience feedback and create adaptive content means it could generate interactive products, such as personalized video content or gamified learning experiences.

By automating these processes, the invention creates scalable, high-quality outputs that can be repurposed across industries like entertainment, marketing, education, and more. Also, it can create: The invention can produce several useful items, including:
Video Content: Complete, AI-generated videos such as films, commercials, training videos, or social media content.
Scripts: Written scripts based on user inputs, useful for filmmakers, content creators, or marketers.
Visual Storyboards: Automated storyboards that serve as pre-visualizations for video or film production.
Virtual Assets: Digital environments, characters, and sets, which can be used in videos, virtual reality (VR), gaming, or augmented reality (AR).
Interactive Content: Customizable, personalized videos based on audience data or preferences.

These outputs offer practical value across industries such as entertainment, education, marketing, and gaming.

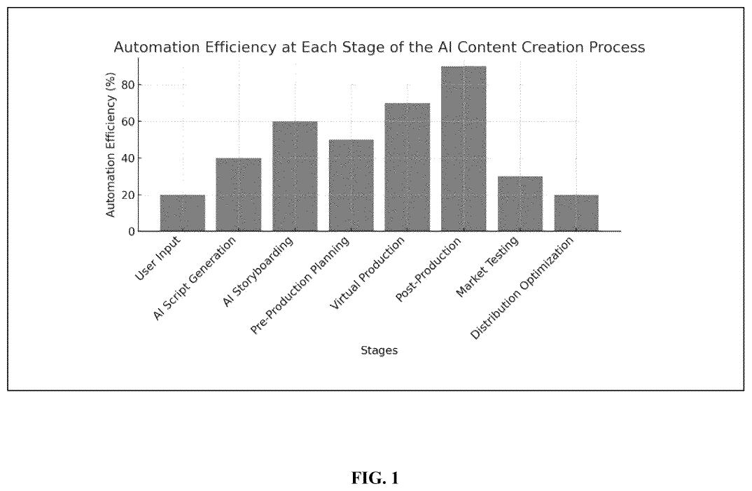

FIG. 1 illustrates a chart of automation efficiency, as a percentage, at each stage of the artificial intelligence (AI) content creation process.

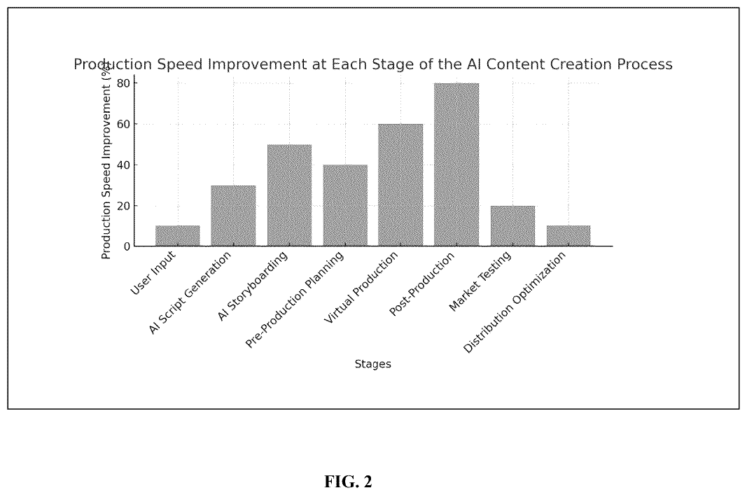

FIG. 2 illustrates a chart of production speed improvement, as a percentage, at each stage of the artificial intelligence (AI) content creation process.

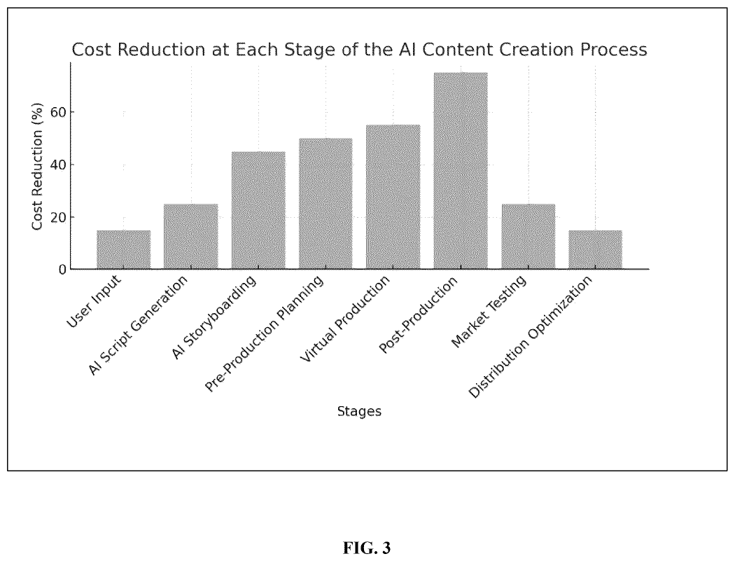

FIG. 3 illustrates a chart of production speed improvement, as a percentage, at each stage of the artificial intelligence (AI) content creation process.

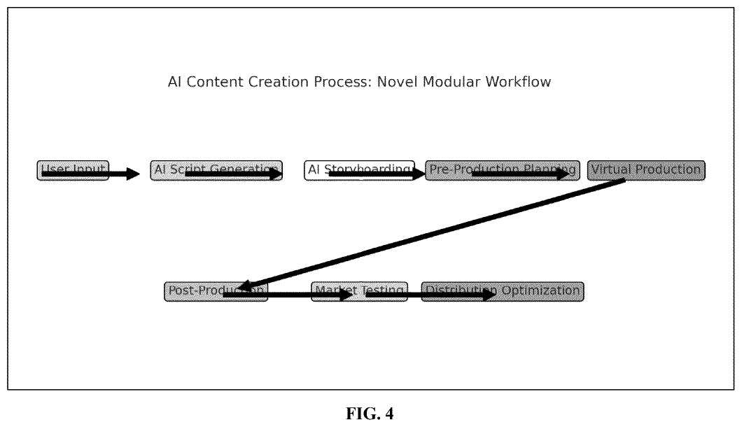

FIG. 4 illustrates a flowchart of one embodiment of the AI content creation process.

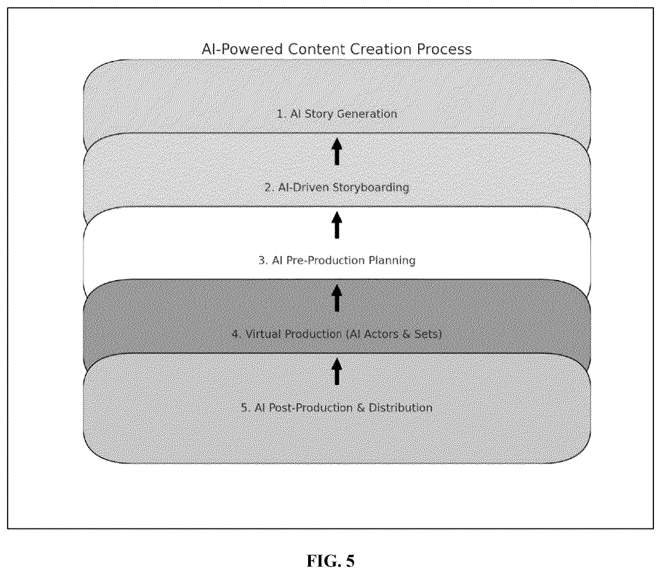

FIG. 5 illustrates flowchart of one embodiment of the AI content creation process.

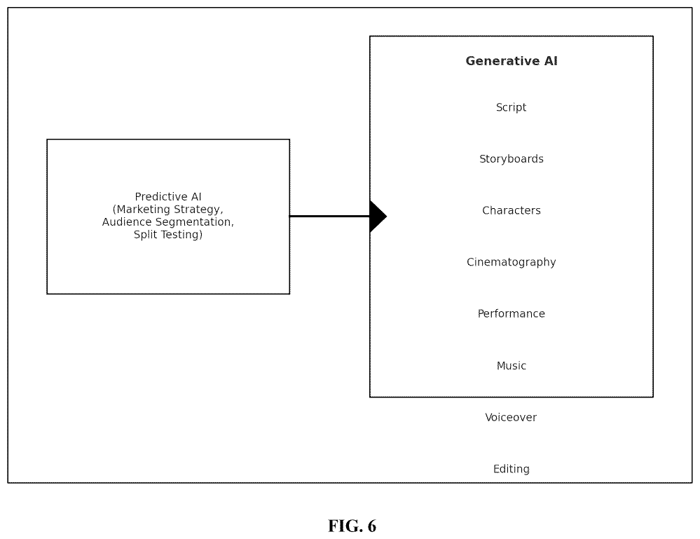

FIG. 6 illustrates a block diagram detailing a process flow of one embodiment of an AI-powered system for automating video content creation from script generation to market distribution.

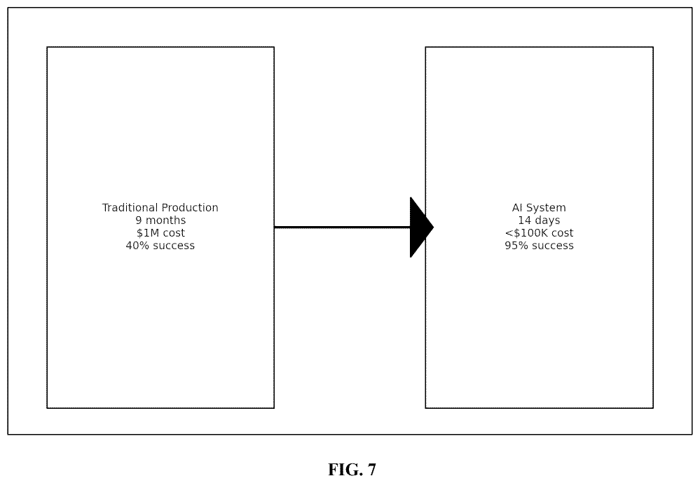

FIG. 7 illustrates a block diagram comparing production metrics (e.g., time, cost, success rate) between traditional content creation and AI enhanced content creation methods.

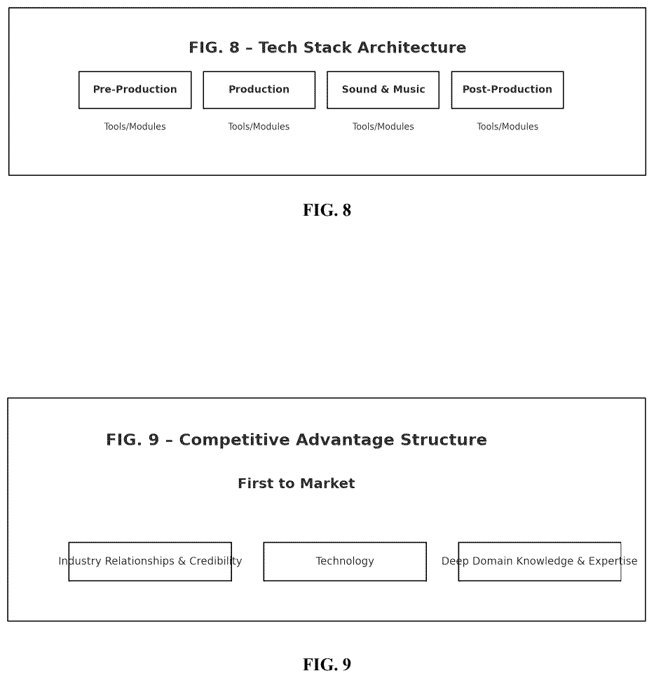

FIG. 8 illustrates a block diagram of a tech stack architecture that may be used to facilitate an AI-powered system for automating video content creation from script generation to market distribution.

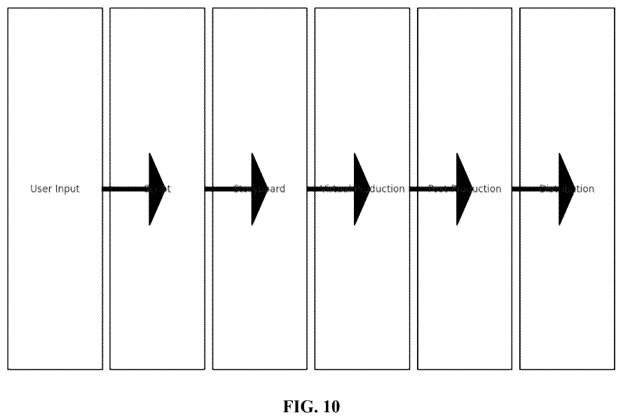

FIG. 9 illustrates a block diagram of advantages of an AI-powered system for automating video content creation from script generation to market distribution.

What is claimed is:

1. A system for automating video content creation, comprising:
a user input interface configured to gather user preferences for guiding content creation;
a natural language processing (NLP) engine configured to generate an initial script based on the user preferences;
a storyboarding module configured to convert the generated script into visual storyboards;
a pre-production planning module configured to automate scheduling, budgeting, and resource allocation for video production;
a virtual production system configured to create digital sets and characters for the video content; and
a post-production module configured to automate editing, special effects, and audio tasks for the video content.
